(19) United States
(12) Patent Application Publication
(10) Pub. No.: US 2004/0158631 A1
(43) Pub. Date: Aug. 12, 2004

(54) Apparatus and methods for monitoring and controlling network activity in real-time

(76) Inventors: Tsung-Yen Dean Chang, Los Altos Hills, CA (US); Chuang Li, Saratoga, CA (US); Bo Xiong, Fremont, CA (US)

Correspondence Address: Nicola A. Pisano, Esq., Suite 200, 11988 El Camino Real, San Diego, CA, 92130, US

(21) Appl. No.: 10/464,230

(22) Filed: Jun. 17, 2003

Related U.S. Application Data
(63) Continuation-in-part of application No. 10/366,028, filed on Feb. 12, 2003.

(51) Int. Cl. G06F 15/173

(52) U.S. Cl. 709/224

(57) ABSTRACT

Apparatus and methods for monitoring and controlling network activity of a network appliances in real-time are provided, in which the network activity is transmitted to at least one controlling network appliance. Internet access filtering technology and instant message technology are combined so that Internet access of a monitoring network appliance may be selectively blocked based upon predefined rules, and Internet access activities, whether blocked or not, may be redirected to multiple controlling network appliances for review based on other predefined rules, wherein the monitoring network appliance and the controlling network appliance may be buddies in an instant message network. The predefined rules may be modified dynamically by sending a command from the controlling network appliance to monitoring network appliance.

### FIELD OF THE INVENTION

This invention relates generally to apparatus and methods for monitoring and controlling network activity. More specifically, the present invention provides apparatus and methods for real-time monitoring and controlling of network activity by broadcasting network activity information in real-time to multiple controlling network appliances without user intervention. The network activity is controlled by a set of rules that may be modified by a controlling network appliance in real-time.

### BACKGROUND OF THE INVENTION

The popularity of the Internet has grown rapidly over the past several years. A decade ago, the Internet was limited to the academic and research community. Today, the Internet has grown into a communications network that reaches millions of people around the world. It provides a powerful and versatile environment for business, education, and entertainment. At any given time, massive amounts of digital information are accessed and exchanged on the Internet by millions of users worldwide with many diverse backgrounds and personalities, including children, students, educators, business men and women, and government officials, among others.

Users may access the Internet through a dial-up modem connected to existing telephone lines, or through high-speed connections including a direct connection to the Internet backbone and connections provided by T1 or T3 lines leased from telephone companies, cable modems, or DSL modems. These high-speed connections may be shared by multiple users on a local area network (“LAN”) through the use of a router, which is a device that handles all the digital information traffic between the Internet and each one of the users in the LAN.

The digital information may be accessed and exchanged through the World Wide Web (hereinafter the “web”), or by using electronic mail, file transfer protocols, or a variety of other applications, including peer-to-peer (“Pr2Pr”) file sharing systems and Instant Messaging (“IM”). Information on the web is typically viewed through a “web browser” such as Internet Explorer, available from Microsoft Corporation, of Redmond, Wash. The web browser displays multimedia compositions called “web pages” that contain text, audio, graphics, imagery and video content, as well as nearly any other type of content that may be experienced through a computer or other network appliance. Network appliances are electronic devices configured with a network access system, such as personal and portable computers, electronic organizers, personal digital assistants (“PDAs”), and wireless telephones, among others.

Besides the web, Pr2Pr file sharing systems and IM have become increasingly popular vehicles for exchanging digital information. Pr2Pr file sharing systems enable users to connect to each other and directly access files from one another's network appliances. Such systems are mostly used for exchanging digital music or image files on the Internet. Examples include the open source systems Gnutella and Napigator.

In addition to digital files, users may also exchange messages with one another by using an IM service. An IM service is primarily used by a subscriber to “chat” with one or more other IM subscribers. Because the exchange of information is almost instantaneous, IM is quicker than ordinary electronic mail and a more effective way to communicate with other users.

To access an IM service, a user registers with an IM service provider to become a subscriber, and, after downloading and installing “IM client” software, connects to the Internet (or other appropriate data network), and enters a selected username and password to log in to an “IM server” maintained by the IM service provider. The IM server maintains a contact list or “buddy list” for each subscriber to allow the subscriber to send an instant message to any one in his/her buddy list, as long as that person, commonly referred to as a “buddy”, is also online. In addition, a subscriber may enter a “chat room” to communicate to any subscriber in the room.

Once a subscriber has logged in to the IM server, his/her presence on the network is made known to all of his/her buddies on his/her buddy list. The subscriber can then engage in typed conversations with his/her buddies and update his/her buddy list to include other subscribers that they desire to communicate with. Because of ease of use and convenient buddy lists, IM has become especially popular among children and teens. Popular IM applications include the freely-distributed ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash.

With the ease of access and distribution of digital information over the Internet, it has become increasingly important to block or filter out offensive or objectionable material that is not appropriate to all users. In particular, adult content displayed on the web may not be appropriate for children, teenagers, or employees during their work hours, and IM exchanges between children, teenagers or employees and certain users may not be acceptable to parents or employers. Furthermore, it may not be acceptable to parents or employers to have their children or employees using IM for long periods of time, or using a Pr2Pr system to exchange inappropriate files. It is therefore important to parents and employers to monitor and block exchanges on the web and other applications such as electronic mail, Pr2Pr systems, and IM.

In response to this need, a number of parental control software programs have been developed to filter out inappropriate content on the web or on other electronic media including CDs and DVDs. These filtering systems may be classified into one or a combination of four major categories: (1) rating-based systems; (2) list-based systems; (3) keyword-based systems; and (4) context-based systems.

A typical rating-based system, such as the SuperScout Web filter developed by Surf Control, Inc., of Scotts Valley, Calif., classifies web sites into different categories based on their content and enables users to define rules that govern access to the different categories. For example, a parent may define a rule allowing access to web sites belonging to an “educational” category and block access to web sites in an “adult” category. While rating-based systems allow users to rely on trusted authorities to categorize web site content, they are not always reliable because many web sites frequently change their content and their classification before the rating-based systems are updated to reflect the changes.

An alternative to using rating-based systems to filter out inappropriate content involves using list-based systems that maintain lists of inappropriate and objectionable web sites, newsgroups, and chat rooms that may be selected by users for blocking, or using keyword-based systems that filter content based on the presence of inappropriate or offending keywords or phrases. However, list-based systems, such as Net Nanny, developed by Net Nanny Software International, Inc., of Vancouver, BC, Cyber Patrol, developed by Surf Control, Inc., of Scotts Valley, Calif., and Cyber Sitter, developed by Solid Oak Software, Inc., of Santa Barbara, Calif., are also unreliable because new web sites, newsgroups, and chat rooms are constantly appearing, and the lists, even when updated, are obsolete as soon as they are released.

In addition, keyword-based systems, such as the Cyber Sentinel system developed by Security Software Systems, of Sugar Grove, 111., also produce poor results since they are likely to block sites that should not be blocked while letting many inappropriate sites pass through unblocked. Because they are based on text recognition, keyword-based systems are unable to block offensive or inappropriate pictures.

To make keyword-based systems more effective, context-based systems, such as the I-Gear web filter developed by Symantec Corporation, of Cupertino, Calif., have been developed to perform a contextual analysis of a web site to be blocked. The I-Gear system employs context-sensitive filtering based on a review of the relationship and proximity of certain inappropriate words to other words on the web site. While I-Gear and other context-based systems are more effective than individual keyword-based systems, they lack the ability to filter electronic content other than text on web pages, and therefore are not guaranteed to block a site containing inappropriate pictures.

In addition to unreliability in blocking unwanted web site material, all of the above mentioned filtering systems do not monitor content that is exchanged through non web-based applications, such as electronic mail and IM. Software monitoring programs, such as Online Recorder, provided by Morrow International, Inc., of Canton, Ohio, and ChatNanny, provided by Tybee Software, Inc., monitor online activity in instant messages, chat rooms, electronic mail, etc., and record the monitored information for later viewing. For example, a parent may install a monitoring program on his children's machines to record his children's online activity, including their IM usernames and passwords, and later access a password protected information viewer provided with the monitoring software to view a record of his children's online activity on any given day.

Although these programs give parents or employers accurate information of the content of messages exchanged via IM or electronic mail and the location of web sites visited, they can only produce a historical account of the users' activity. That is, they are not able to provide real-time monitoring to prevent the unwanted activity from occurring, or stop undesirable activity as it is happening. The monitoring programs may be used solely for monitoring purposes and are not able to perform any actions on the monitored user, such as blocking the user from seeing a particular web site. Furthermore, in order for these monitoring programs and other web-filtering systems to be effective, they must be installed on every network appliance that is to be monitored.

Besides the above mentioned software monitoring programs, some hardware products, such as the RP614 router, provided by NETGEAR, Inc., of Santa Clara, Calif., have limited monitoring capabilities. The RP614 router may be configured to provide reports of online activity for every appliance in a LAN and also limit access to predetermined web sites. However, this router does not provide real-time monitoring functionality and its ability to prevent unwanted material from being accessed is limited to the predetermined web sites. Additionally, the user must log on to the router in order to obtain activity reports, and therefore is not able to remotely monitor network activity from a device outside the LAN.

Network activity may be monitored remotely with the use of remote network management software, including Netop, provided by Danware Data A/S, of Birkerod, Denmark, pcAnywhere, provided by Symantec Corporation, of Cupertino, Calif., and GoToMyPC, provided by Expertcity, of Santa Barbara, Calif. These applications enable users to view the screen and control the keyboard, mouse, files, resident software, and network resources of any remote computer, regardless of its location. For example, a parent may use one of these applications to monitor his children's computers at home while the parent is away on a business trip and an IT employee at a company may use one of these applications to help a company's employee solve a problem, install a software, or perform other actions on the employee's laptop computer while the employee is away from his office. In short, these applications enable users to monitor and control a computer or network remotely and to perform all actions as though they were there in person.

The drawback is that these applications may be slow and generate unnecessary traffic when used to monitor network activity of a remote computer. Since most of these applications transmit the image of the screen of the remote computer being monitored instead of transmitting the network traffic, i.e., packets, generated by the activity, the unnecessary traffic generated is in the form of screen backgrounds and other graphic displays, local application and other pop-up windows, error messages, etc. Transmitting this unnecessary traffic may result in delays, which may ultimately prevent the activity from being monitored in real-time.

Additionally, these applications may require the user monitoring the remote computer to send a request to a server or to the remote computer every time the user desires to view information pertaining to activities in the remote computer. That is, these applications may not be used to monitor remote network activity in real-time without user intervention. Further, these applications may not be used to enable a device to monitor the activity of another remote device without user intervention.

In view of the foregoing, it would be desirable to provide apparatus and methods for real-time monitoring and controlling of local network activity.

It further would be desirable to provide apparatus and methods by which a monitoring network appliance monitors its network activity and transmits information regarding that network activity in real-time to at least one controlling user and controlling network appliance, without user intervention.

It also would be desirable to provide apparatus and methods by which a monitoring network appliance monitors its network activity, and communicates information regarding that monitoring to a controlling user and controlling network appliance and responds to commands from the controlling user or controlling network appliance to perform actions that control the network activity of the monitoring network appliance in real-time.

It also would be desirable to provide apparatus and methods by which a monitoring network appliance monitors network activity and transmits information regarding that network activity in real-time to a controlling network appliance, without user intervention, and using a communication routine selected from a plurality of communication routines to transmit the network activity information based on the IP addresses of the monitoring network appliance and the controlling network appliance.

### SUMMARY OF THE INVENTION

In view of the foregoing, it is an object of the present invention to provide apparatus and methods for real-time monitoring and controlling of local network activity without user intervention.

It is a further object of the present invention to provide apparatus and methods by which a monitoring network appliance monitors its network activity and transmits information regarding that network activity in real-time to at least one controlling user and controlling network appliance, without user intervention.

It is also an object of the present invention to provide apparatus and methods by which a monitoring network appliance monitors its network activity, communicates information about that monitoring to at least one controlling user and controlling network appliance and responds to commands from the controlling user or controlling network appliance to perform actions that control the network activity of the monitoring network appliance.

It is also an object of the present invention to provide apparatus and methods by which a monitoring network appliance monitors network activity and transmits information regarding that network activity, in real-time, to a controlling network appliance without user intervention and using a communication routine selected from a plurality of communication routines to transmit the network activity information based on the IP addresses of the monitoring network appliance and the controlling network appliance.

These and other objects of the present invention are accomplished by providing apparatus and methods by which a network appliance monitors its network activity and transmits information about that network activity, in real-time, to at least one controlling user and network appliance without user intervention.

The invention combines Internet access filtering technology and instant message technology so that Internet access of a monitoring network appliance may be selectively blocked based on predefined rules, and/or Internet access activities, whether blocked or not, may be redirected to one or more controlling network appliances based on another set of predefined rules. The predefined rules preferably may be modified dynamically by sending a command from the controlling network appliance to monitoring network appliance.

The network activity information may correspond to the network activity of a network appliance directly connected to the Internet or the network activity of a network appliance in a local area network (“LAN”) connected to the Internet by means of a network gateway, which is an embedded device that acts as an entrance to another network, such as a router, a modem, switch, hub, bridge, or other embedded device. In both cases, the network activity information may be broadcast to one or more controlling users or network appliances that desire to monitor and control the network activity.

The network appliances or the network gateway in the LAN to be monitored are hereinafter interchangeably referred to as monitoring network appliances (“MNAs”). Remote network appliances or network gateways that receive network activity information from MNAs are hereinafter interchangeably referred to as controlling network appliances (“CNAs”).

Information passed between the MNAs and CNAs is preferably transmitted by one of several pathways, including point-to-point (“P2P”) transmission, hybrid point-to-point (“H-P2P”) transmission or client-server transmission (such as Instant Message Protocol). A P2P transmission involves the transmission of network packets, e.g., IP or TCP/IP packets, between two parties and may occur whenever the parties are assigned a communicable IP address, i.e., an IP address that is reachable from any device in the Internet. A hybrid point-to-point (“H-P2P”) transmission occurs where one or both parties are assigned a private and non-communicable IP address.

A MNA preferably includes a monitoring engine, a connection engine, a communication engine, a command set interpreter and a reporting engine. The monitoring engine is a program capable of reading the contents of each network packet passed between the MNA and the Internet and determining the network activity represented in the packets. The monitoring engine preferably serves as a two-way traffic controller, controlling traffic coming from and going to the Internet. Alternatively, the monitoring engine may be configured to screen packets passed between the MNA and the Internet and send network activity information to one or more CNAs, which then provides instructions to the MNA regarding handling of the incoming and outgoing network activities of the MNA, as well as optionally displays the network activity to the control user.

The connection engine is a program that conducts an IP address discovery exchange between the MNA and the CNA to determine the type of IP address assigned to each of them, and determines the communication pathway to be used for transmission of network activity information. The communication engine is a program that establishes a suitable connection between the MNA and CNA according to the type of IP address assigned to the CNA. The command set interpreter is a program that receives and executes commands sent by the CNA that control operation or the connection status of the MNA. The reporting engine is a program that records network activity information of the MNA into logs and sends the logs to the CNA.

A CNA preferably includes a connection engine, a communication engine, and optionally, a display engine. The connection engine and communication engine perform functions similar to the corresponding programs of the MNA, while the display engine displays the network activity information received from the MNA.

The CNA may passively analyze the information received from the MNA without performing any action or may direct the MNA to perform an action using a command selected from a command set, e.g., to direct the MNA to block a particular web site or chat room. The command set has a list of commands that a CNA may use to direct the MNA to perform an action that control the network activity of the MNA, such as a “block” command to block the MNA from accessing a web site or chat room, a “disconnect” command to disconnect the MNA from the Internet, and a “time out” command to limit the time the MNA is connected to the Internet, among others.

In accordance with the principles of the present invention, a single CNA may control one or more MNAs, and conversely, a single MNA may send network information to one or more CNAs. The MNA may be preprogrammed with an instant message buddy list that contains CNAs' user names and passwords so that the network activities can be sent from MNA to CNAs without user intervention. In addition, a network appliance may function as a MNA and as a CNA simultaneously.

The controlling users and remote network appliances or network gateways receiving the network activity information collected and sent by the MNA act as a controlling network appliance. Intelligence may be programmed in the remote network appliances to automatically send commands to the MNA, or, the intelligence may be programmed in the MNA itself so that the MNA may be controlled without user intervention.

In accordance with another aspect of the present invention, the monitoring engine of either or both of the MNA or the CNA optionally comprises a packet analyzer. Generally, the packet analyzer is a program that intercepts traffic to and from the MNA or CNA, identifies the type of packet, and then analyzes and processes the packet before returning the packet to the traffic flow. The packet analyzer employed in the MNA preferably identifies the packet by its type, e.g., HTTP, instant message, etc., by comparing the packet against a predefined set of templates that specify how the packet is configured.

Once the protocol of the packet is determined, the packet analyzer analyzes the packet against defined rules to determine whether and how to modify the packet before returning it to the traffic flow as well as to determine whether and how to send the packet to the CNA. For example, for a packet going from MNA to the Internet, if the packet is determined to be an URL or an instant message in the approved list, the packet will be sent to the destination web site or the instant message server. The same packet will also be analyzed to determine whether it is to be sent to the CNA for display.

On the other hand, if the packet is determined to contain the URL of a website listed on a list of blocked sites, contain an instant message to be sent to a non-approved receiver, or contain certain information that is not approved to be sent out, the packet will be blocked before it is sent to the Internet. Again the blocked packet also will be analyzed to determine whether it is to be sent to the CNA for display.

For the packet incoming from Internet to the MNA, if the packet is determined to contain an URL or an instant message in the approved list or not in the blocked list, the packet will be passed to the MNA. If the packet is determined to contain an URL or an instant message not in the approved list, or contains information not allowed to be received by the MNA, the packet will be blocked. The incoming packet, whether it is blocked or is passed to the MNA, will be checked against a predefined rule to determine if the incoming packet will be sent to the CNA for display.

Alternatively, or in addition, the display engine of the CNA may include a packet analyzer for identifying and analyzing the content of packets forwarded to the CNA by the MNA. For example, the packet analyzer in the CNA may be used to analyze the content of any special packets transmitted by the MNA for proper display in the CNA.

Advantageously, the systems and methods of the present invention enable one or more MNAs to monitor their own network activity in real-time, communicate monitoring information to one or more CNAs and respond to commands from the CNAs to perform actions that control the network activity of the one or more MNAs in real-time. In addition, the systems and methods of the present invention enable a CNA to access and act upon past recorded network activity.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic diagram of an exemplary embodiment of the network environment in which the present invention operates;

FIG. 2 is a schematic diagram of another exemplary embodiment of the network environment in which the present invention operates;

FIG. 3 is a schematic diagram of components of a preferred embodiment of the present invention;

FIG. 4 is a schematic diagram illustrating how a data packet is screened and analyzed by the packet analyzer in the monitoring network appliance;

FIG. 5 is a schematic diagram illustrating how a data packet is screened and analyzed by the packet analyzer in the controlling network appliance;

FIG. 6 is a flow chart for an exemplary IP discovery exchange between a MNA and a CNA when a MNA logs on;

FIG. 7 is a flow chart for an exemplary IP discovery exchange between a MNA and a CNA when a CNA logs on;

FIG. 8 is a flow chart for monitoring network activity and communicating the monitored activity to a CNA;

FIG. 9 is a flow chart for performing an action based on monitored network information; and

FIG. 10 is an illustrative diagram of a list of commands in the command set.

### DETAILED DESCRIPTION OF THE DRAWINGS

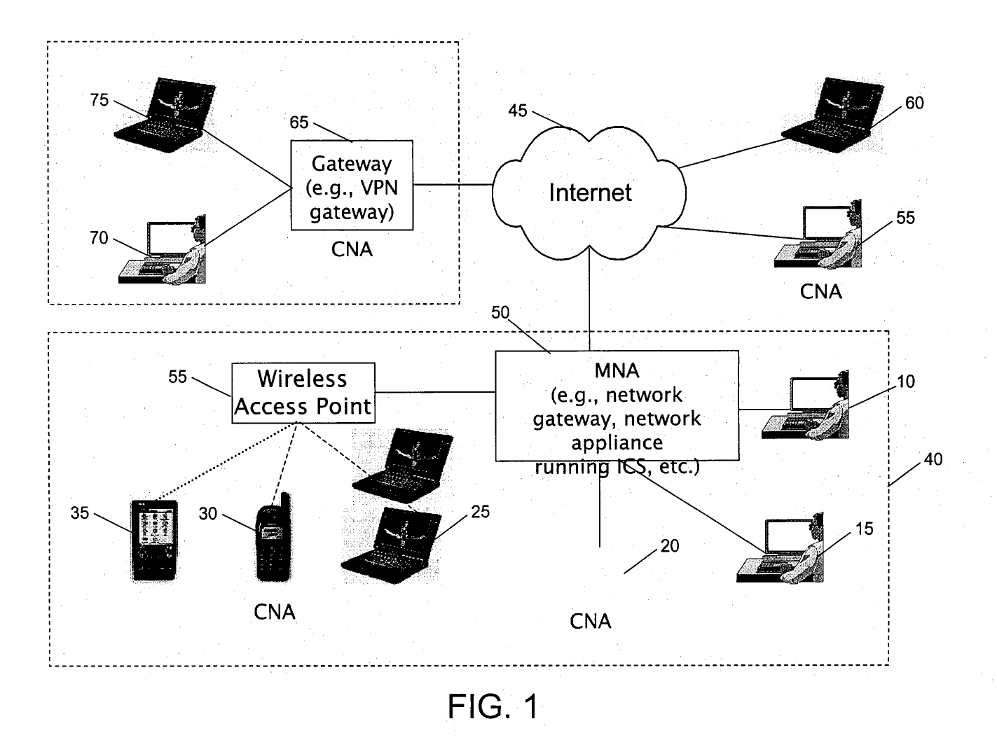

Referring now to FIG. 1, a schematic diagram of an exemplary embodiment of the network environment in which the present invention operates is described. Network appliances 10-35 form local area network (“LAN”) 40 that connects to Internet 45 through MNA 50. Internet appliances 10-20 connect to MNA 50 through a wired connection, while Internet appliances 25-35 connect to MNA 50 by means of a wireless connection through wireless access point 55.

MNA 50 is a network appliance equipped with a monitoring engine, which is a program capable of reading the contents of each network packet transmitted from/to LAN 40 to/from Internet 45 and collecting status information regarding the activity of all network appliances in LAN 40. MNA 50 may be a network gateway that acts as an entrance to another network, such as a router, a modem, switch, hub, bridge, or other embedded device. MNA 50 may also include a combination of network entrance devices, such as a router and a high-speed modem, including a DSL modem and a cable modem, among others. The router may be a stand-alone device or integrated into the high-speed modem. In addition, MNA 50 may be a network appliance running an Internet Connection Sharing (“ICS”) routine for sharing a single connection to Internet 45 among network appliances 10-35.

The status information collected by MNA 50 regarding network activity in LAN 40 is transmitted to one or more CNAs, accessible by one or more controlling users. In one embodiment, the MNA includes a packet analyzer that applies a series of predefined rules to control operation of the MNA, e.g., by blocking outbound traffic to prohibited websites or blocking inbound traffic from non-approved sources. A controlling user accessing a CNA may passively analyze the information received from MNA 50 to oversee activity in LAN 40. Alternatively, a controlling user may analyze the information received from MNA 50 to determine whether any immediate or future action to control network activity in LAN 40 is to be taken. If so, the controlling user may direct MNA 50 to perform an action to control network activity in LAN 40 by sending a message to MNA 50 with a command to be executed on LAN 40.

For example, a CNA may be network appliance 20 used by a parent to monitor activity in network appliance 10 used by his children to access Internet 45. In another example, LAN 40 may be a business network and CNA 20 may be accessible by an IT employee to oversee the online activity of all employees working on network appliances in LAN 40. In yet another example, the CNAs may be remote network appliances 55-60 accessible by a parent while traveling away from his home network, e.g., LAN 40, to oversee online activity of his children. The CNA may also be a virtual private network (“VPN”) gateway or other remote gateway or appliance, e.g., gateway 65, that forwards the information received from MNA 50 to the controlling user, e.g., parent, which may be accessing network appliances 70-75 at work to oversee online activity of his children at their home LAN 40.

It should be understood by one skilled in the art that a single CNA may monitor one or more MNAS, and a single MNA may be monitored by one or more CNAs. It should also be understood by one skilled in the art that any one of appliances 10-35 and gateway 50 may be a MNA and/or a CNA simultaneously.

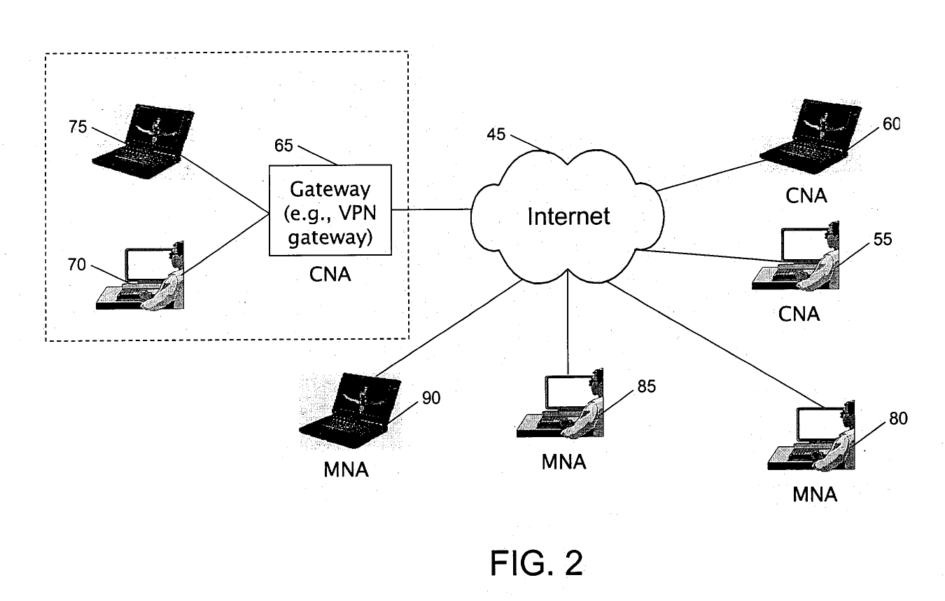

Referring now to FIG. 2, a schematic diagram of another exemplary embodiment of the network environment in which the present invention operates is described. In this embodiment, MNAs 80-90 are network appliances that connect to Internet 45 directly, such as PCs 80 and 85 and notebook 90. Each of MNAs 80-90 may be monitored by one or more of CNAs 55-65 simultaneously, and each of CNAs 55-65 may monitor one or more of MNAs 80-90 simultaneously.

MNAs 80-90 are each equipped with a monitoring engine to collect status information regarding the network activity of its users. The MNAs may include predefined rule sets, or rules that are dynamically updated by commands received from the CNAs, that control traffic to and from the MNAs from the Internet, as described hereinbelow. The status information collected by the MNAs is transmitted to one or more of CNAs 55-65, which may passively oversee the network activity of MNAs 80-90 or analyze the information received to determine whether any immediate or future action to control the network activity of MNAs 80-90 is to be taken. CNAs 55-65 also may direct MNAs 80-90 to perform an action, in real time, to control the network activity of the MNAs by sending a message to MNAs 80-90 with a command to be executed, for example, CNA 55 may direct MNA 80 to block a given web site or chat room.

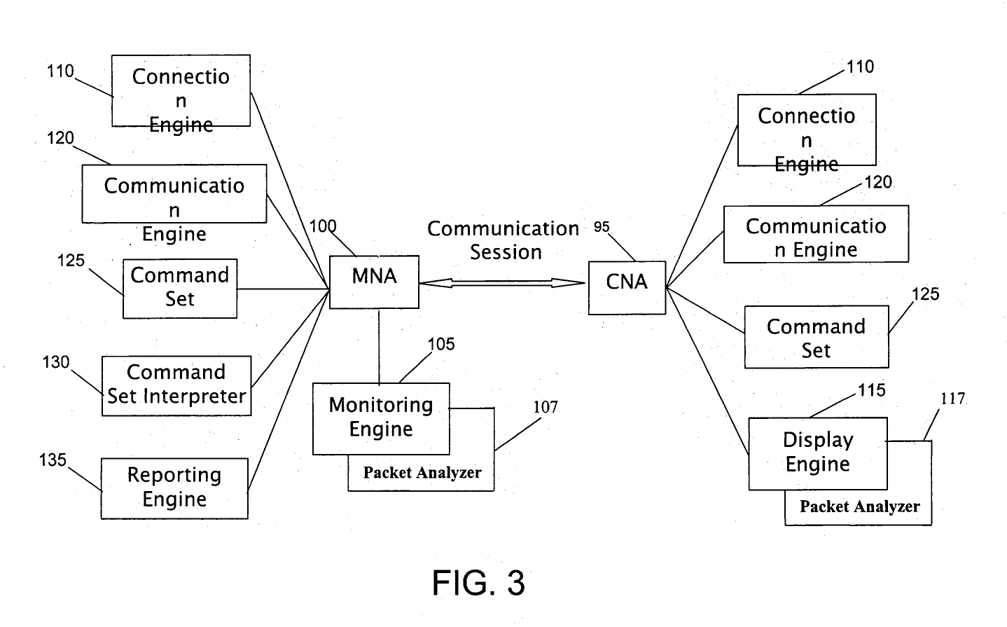

Referring now to FIG. 3, a schematic diagram of the software components used in a preferred embodiment of the present invention is described. MNA 100 preferably includes: (1) monitoring engine 105 having packet analyzer 107; (2) connection engine 110; (3) communication engine 120; (4) command set 125; (5) command set interpreter 130; and (6) reporting engine 135. CNA 95 preferably includes: (1) connection engine 110; (2) communication engine 120; and (3) command set 125. Optionally, CNA 95 may include display engine 115, having packet analyzer 117, that displays the network activity information transmitted by MNA 100.

Monitoring engine 105 is a program embedded in MNA 100 for reading the contents of each network packet transmitted between MNA 100 and Internet 45. Monitoring engine 105 determines the network activity represented in the packets, such as URLs accessed, chat rooms visited, e-mails sent and received, and instant messaging (“IM”) sessions, among others. Monitoring engine 105 of MNA 100 preferably includes packet analyzer 107. Packet analyzer 107 first analyzes incoming packets to determine the protocol, and thus configuration of the packet, and then applies a predefined set of rules for filtering or modifying the packet before returning the packet to the traffic flow.

Alternatively or in addition, packet analyzer 107 may apply another set of predefined rules to determine whether particular network activity should be transmitted to one or more controlling network appliances. For example, packet analyzer may determine that a particular data packet contains unsuitable contents, e.g., content or a sexual or violent nature, or in a corporate environment, that reflect sensitive business information. In such a case, the presence of such content may select the network activity as appropriate for transmission to one or more CNAs for review.

Connection engine 110 of MNA 100 determines the type of IP address assigned to CNA 95, i.e., communicable or non-communicable, and selects the corresponding communication pathway to be used by communication engine 120 to exchange network activity information between MNA 100 and CNA 95.

In a preferred embodiment, connection engine 110 may be an Instant Message Client (“IMC”) with MNA 100 and CNA 95 as buddies in the same IM network. The controlling user selects a user name for the MNA 100 and builds a buddy list that contains all of the CNAs' user names and passwords during configuration of the MNA 100. MNA 100 is logged into an IM server with its own user name. The IM server may be any IM server used by an IM service, such as ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash., among others. The IMC is a program for making requests to the IM server, which fulfills the requests. By launching an IMC, MNA 100 can send instant messages to any user and network appliance on its buddy list.

Once MNA 100 is logged into an IM server, it sends instant messages containing its IP address to all of its buddies, i.e., to all the CNAs that may monitor and control the network activity collected by MNA 100, including CNA 95. The instant messages are first sent to the IM server and forwarded to the CNAs if they are online. If CNA 95 is not online when an instant message is sent, the CNA 95 will not be notified at that time. However, when CNA 95 logs on to the server later, the MNA is notified by CNA's presence as the CNA 95 is in MNA's buddy list that is in the IM server. The MNA will then send an instant message containing MNA 100's IP address to CNA 95. CNA 95 also sends an instant message to MNA 100 containing CNA 95's IP address.

Communication engine 120 transmits network activity information to CNA 95 in one of four ways, depending on the type of IP addresses assigned to CNA 95 and MNA 100:

(1) the transmission may be a bi-directional P2P transmission (if both MNA 100 and CNA 95 have communicable IP addresses);

(2) if MNA 100 has a communicable IP address but CNA 95 has a non-communicable IP address, the transmission may be a H-P2P transmission. In this case MNA 100 designates a local information buffer to store the network activity information from which CNA 95 periodically pulls information. MNA 100 may also designate a command buffer to receive commands sent by CNA 95 periodically;

(3) if MNA 100 has a non-communicable IP address but CNA 95 has a communicable IP address, the transmission may be a H-P2P transmission where CNA 95 designates a local information buffer for MNA 100 to which network activity information periodically is sent. CNA 95 may also designate a local command buffer to store control commands for MNA 100 to retrieve periodically; and

(4) if both MNA 100 and CNA 95 have non-communicable addresses, the transmission may be a client-server transmission where MNA 100 and CNA 95 relay information by means of a server, e.g., an IM server.

Once MNA 100 obtains the IP address of CNA 95 using connection engine 110, the MNA uses communication engine 120 to try to establish a P2P connection with CNA 95 to determine the type of IP address assigned to CNA 95, i.e., communicable or non-communicable, by sending a packet to CNA 95. If CNA 95 has a communicable IP address, it receives the packet and subsequently sends an acknowledgment packet to MNA 100 through instant message. If CNA 95 has a non-communicable address, however, it does not receive MNA 100's packet nor it is able to send an acknowledgment packet to MNA 100. MNA 100 determines the type of IP address assigned to CNA 95 based on whether it receives the acknowledgment packet from CNA 95. The CNA 95 may can use the same technique to determine the type of IP address assigned to MNA 95. MNA 100 then begins to transmit the network activity information to CNA 95 in one of the four ways described above, depending on the type of IP addresses assigned to MNA 100 and to CNA 95.

Command set interpreter 130 is provided in MNA 100 to receive commands in command set 125 sent by CNA 95 and to execute those commands. Specifically, after receiving the information from MNA 100, CNA 95 may direct MNA 100 to perform actions to control the network activity monitored by MNA 100, such as blocking access to a given web site or chat room. CNA 95 directs MNA 100 to perform an action by using a command in command set 125 embedded in MNA 100. The commands are relayed to MNA 100 depending on its IP address, as described above.

Command set 125 is a list of commands that CNA 95 may use to direct MNA 100 to perform an action to control the network activity monitored by MNA 100, such as a “block” command to block MNA 100 from accessing a web site or chat room, a “disconnect” command to disconnect MNA 100 from Internet 45, and a “time out” command to limit the time MNA 100 is connected to Internet 45, among others.

Reporting engine 135 optionally is provided in MNA 100 to record network activity information into logs and send the logs to CNA 95. The logs may be transmitted to CNA 95 via IM when CNA 95 is online, posted on a secure web site accessed only by the controlling user with a security key, or transmitted by other means, such as via electronic mail, voice mail, among others. The logs may also be periodically pulled by CNA 95 when CNA 95 is assigned a non-communicable address and MNA 100 is assigned a communicable IP address. The logs may be pulled by using FTP, or other network protocols.

Still referring to FIG. 3, CNA 95 has connection engine 110, communication engine 120, and command set 125. Connection engine 110 and communication engine 120 enable the CNA to receive the IP address of one or more MNAs corresponding to that CNA, and to establish a communications pathway based using that IP address, as described above. Command set 125 consists of the commands that CNA 95 may direct to MNA 100 to control operation of the MNA. Optionally, or in addition, display engine 115 of CNA 95 enables the CNA to display network activity information received from the MNA, and may include packet analyzer 117 for analyzing data packets received from MNA 100.

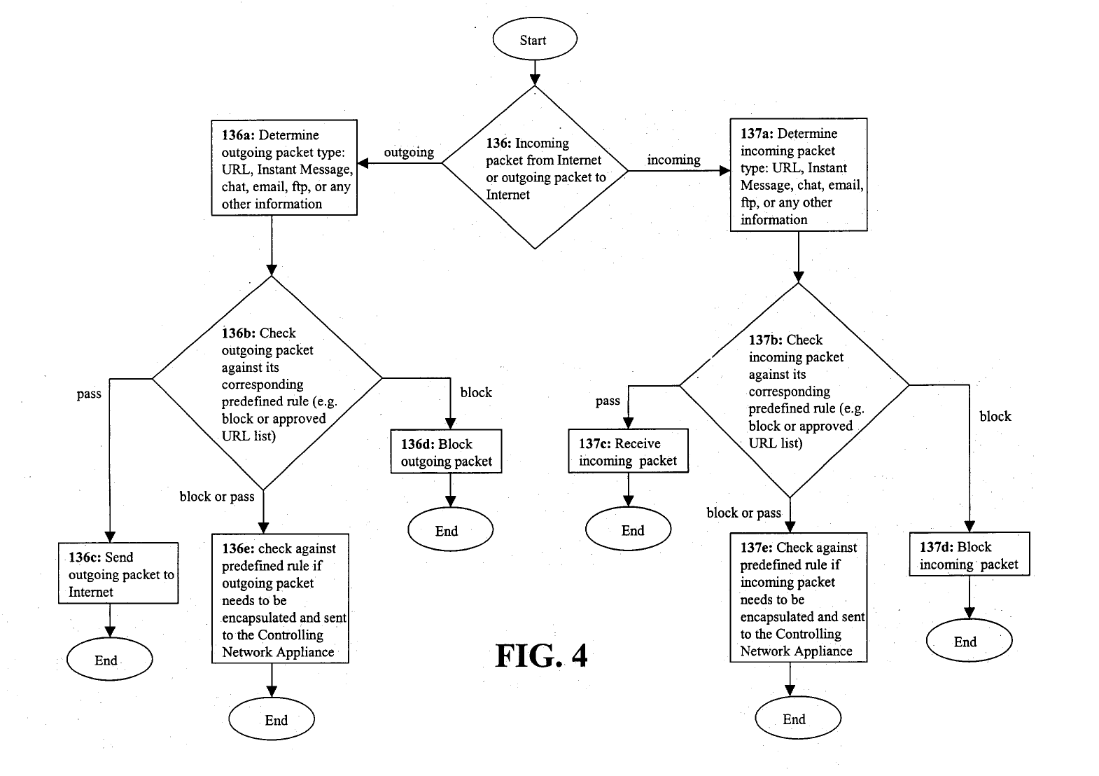

Referring now to FIG. 4, the process of analyzing incoming packets from the Internet and outgoing packets to the Internet in the MNA is described. Packet analyzer 107 determines if the packet is incoming from the Internet (inbound) or outgoing to the Internet (outbound) at step 136. For an outbound packet, packet analyzer 107 first determines the packet type, e.g., the URL of a web site, an instant message, a CHAT room discussion, an email, a FTP file upload, or any other information at step 136a.

At step 136b, each outbound packet is checked against a set of predefined rules, such as an approved list or a blocked list, based on its packet type. If the packet passes the predefined rule, it is sent to the Internet at step 136c. If the packet does not pass the applicable predefined rule, e.g., it is destined for an address on the “blocked” list or not in the approved list, the outbound packet is not sent to the Internet at step 136d. At step 136e, based on another predefined rule, the outbound packet, whether it is being blocked or passed to be sent to the Internet, may be encapsulated in a proprietary packet and sent to the CNA for review.

At step 137a, for an inbound packet to MNA, packet analyzer 107 first determines the packet type. At step 137b, each incoming packet is checked against a set of predefined rules (such as an approved list or a blocked list) based on its packet type. If the packet passes the predefined rule for the corresponding packet type, the inbound packet is received and forwarded to normal traffic flow, at step 137c. If the packet does not pass the predefined rule (e.g., it is in the blocked list or not in the approved list), the inbound packet is blocked from receipt by the MNA, at step 137d. At step 137e, based on yet another predefined rule, the inbound packet, whether it is blocked or passed to the normal traffic flow, may be encapsulated in a proprietary packet and sent to the CNA for monitoring.

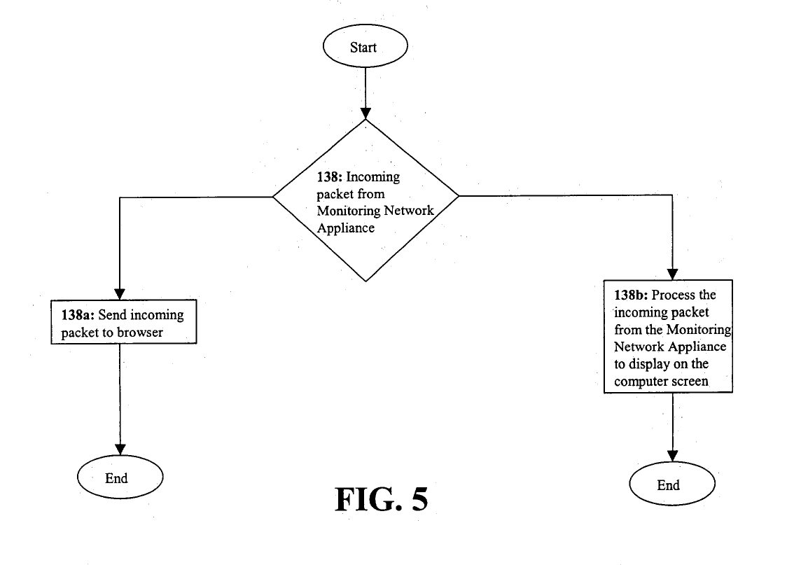

Referring to FIG. 5, the process of analyzing an inbound packet from the Internet in the CNA is described. At step 138, packet analyzer 117 of display engine 115 first determines if the inbound packet type is corresponds to a proprietary packet sent from the MNA. If the packet is not the proprietary packet, the incoming packet is received and sent to the browser at step 138a. If the inbound packet is the proprietary packet sent by the MNA, the inbound packet is processed and passed to display engine 115 for display on the computer at step 138b.

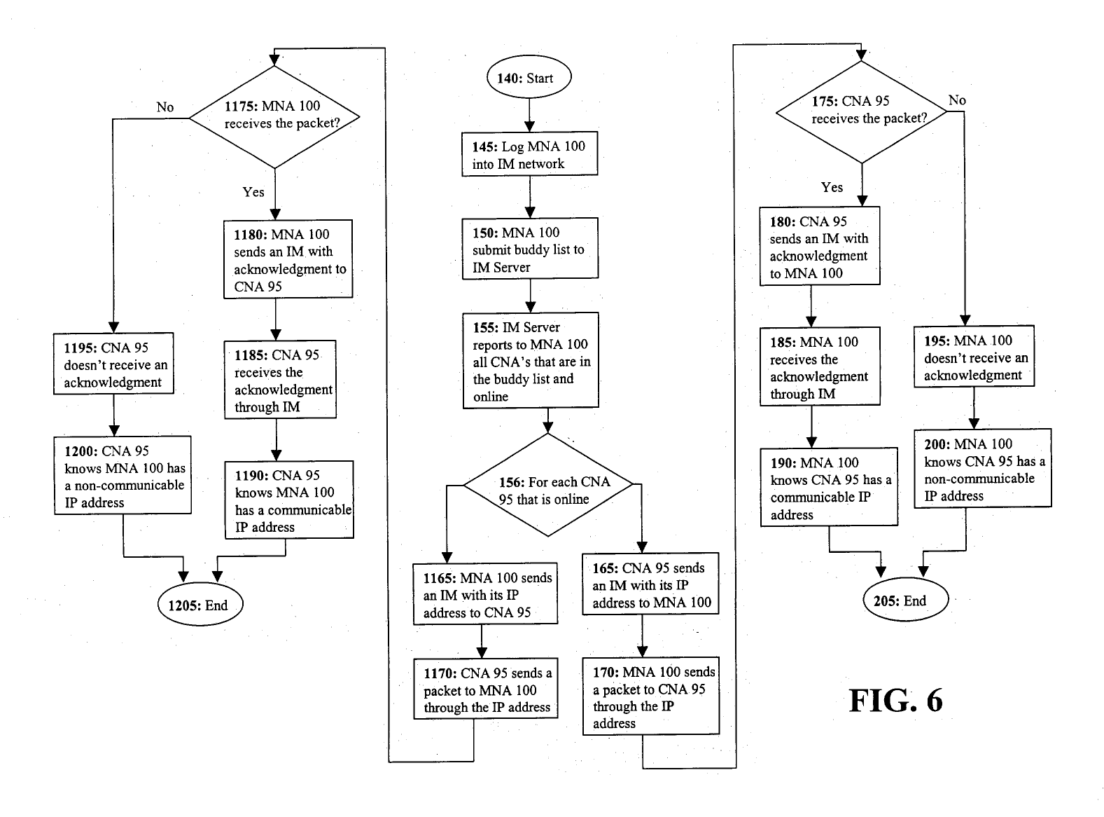

Referring now to FIG. 6, a flow chart for an exemplary IP discovery exchange between a MNA and a CNA is described when MNA logs on. At step 145, connection engine 110 logs MNA 100 into an IM server of an IM network in which both MNA 100 and CNA 95 are buddies.

At step 150, MNA 100 submits a buddy list to the IM server. At step 155, IM server reports to MNA all CNAs that are in the buddy list and are on-line. For each CNA that is on-line, steps 165 through 205 illustrate how MNA discovers whether or not CNA has communicable IP address. Steps 1165 through 1205 illustrate the method by which the CNA discovers whether or not MNA has communicable IP address.

Specifically, at step 165, CNA 95 sends an instant message with its IP address to MNA 100. Once MNA 100 has the IP address of CNA 95, at step 170 the MNA uses communication engine 120 to try to establish a P2P connection with CNA 95 to determine the type of IP address assigned to CNA 95, i.e., communicable or non-communicable, by sending a packet to CNA 95. If CNA 95 receives the packet, at step 175, then the CNA sends an IM with acknowledgment to MNA 100, at step 180. MNA 100 receives the IM acknowledgment at step 185 and thus determines that CNA 95 has a communicable IP address, at step 190. If CNA 95 does not receive the packet sent by MNA 100, at step 175, CNA 95 is unable to acknowledge the packet. If MNA 100 doesn't receive an acknowledgment packet from CNA 95 within a given time period, at step 195, the MNA determines that CNA 95 has a non-communicable IP address, at step 200.

Connection engine 110 of CNA 95 undergoes a similar process to first obtain the IP address of MNA 100, and to attempt to establish a communications with the MNA at steps 1165 through 1205. At step 1165, MNA 100 sends an instant message with its IP address to CNA 95. Once CNA 95 has the IP address of MNA 100, it uses communication engine 120 at step 1170 to try to establish a P2P connection with MNA 100 to determine the type of IP address assigned to MNA 100, i.e., communicable or non-communicable, by sending a packet to MNA 100.

If MNA 100 receives the packet, at step 1175, the MNA sends an IM with acknowledgment to CNA 95 at step 1180. CNA 95 receives the IM acknowledgment at step 1185 and the CNA determines that MNA 100 has a communicable IP address at step 1190. Otherwise, if MNA 100 does not receive the packet sent by CNA 95, at step 1175, it is unable to acknowledge the packet. If CNA 95 doesn't receive an acknowledgment packet from MNA 100 within a given time period, at step 1195, the CNA determines that MNA 100 has a non-communicable IP address, at step 1200.

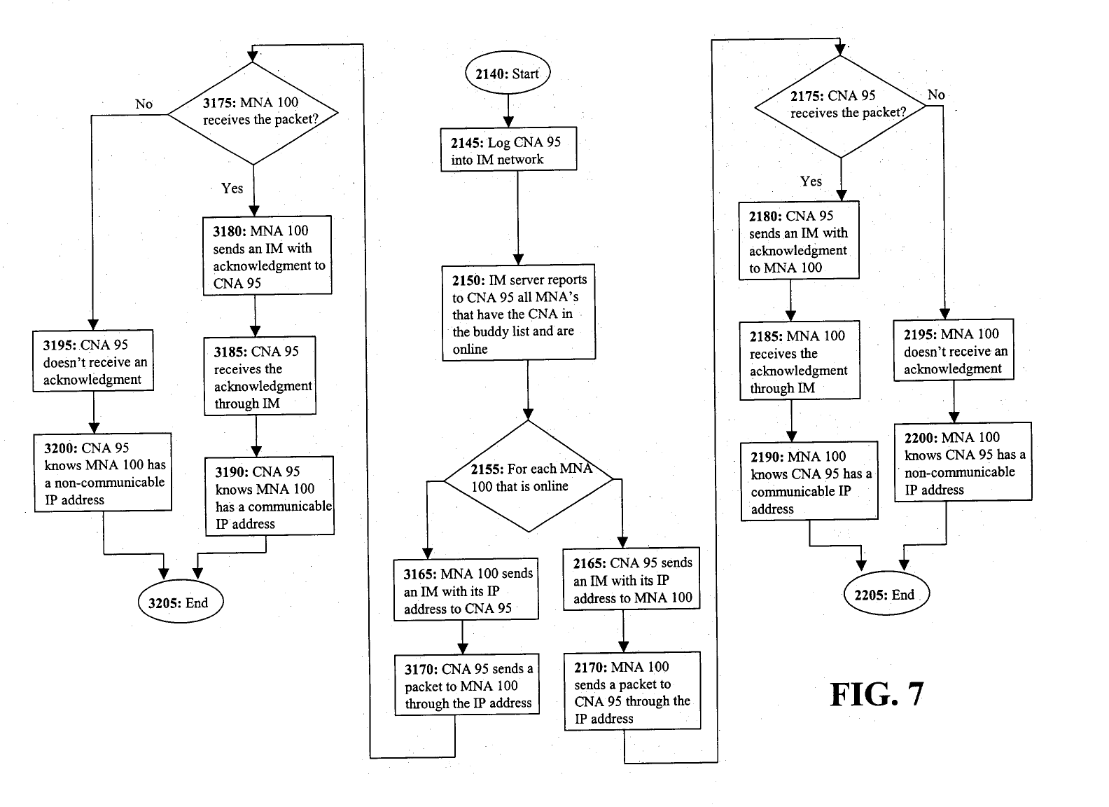

Referring now to FIG. 7, a flow chart for an exemplary IP discovery exchange between MNA 100 and CNA 95 is illustrated when CNA 95 logs on. At step 2145, connection engine 110 logs CNA 95 into an IM server of an IM network in which both MNA 100 and CNA 95 are buddies. At step 2150, IM server reports to CNA 95 all MNAs that have the CNA 95 in the buddy list and are on-line. At step 2155, for each MNA that is on-line, the methods described hereinabove with respect to FIG. 6 are applied, to determine whether each of the MNA and CNA IP address is communicable or non-communicable.

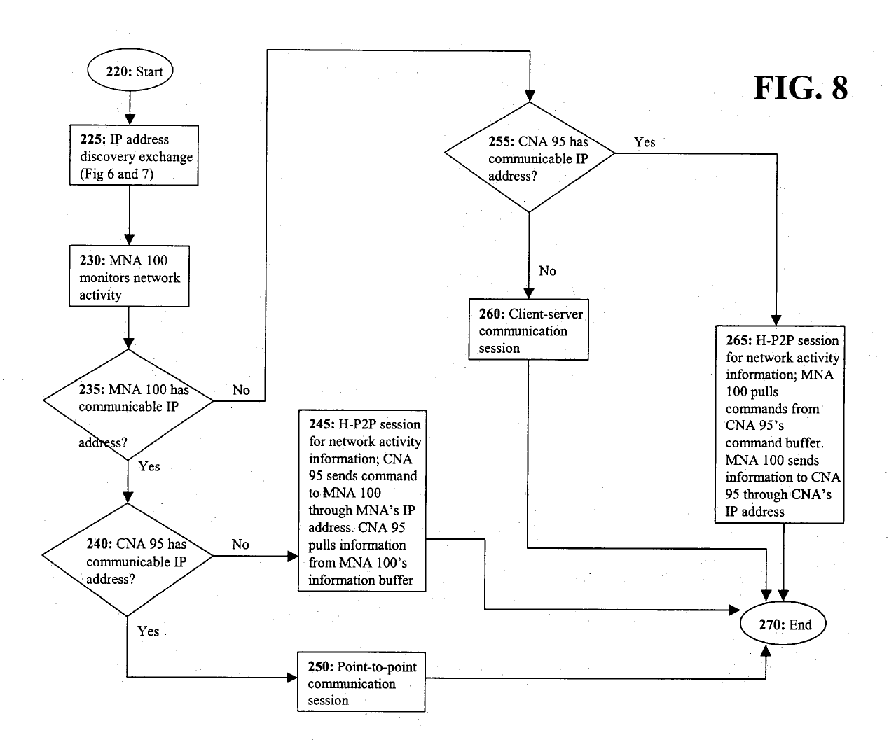

Referring to FIG. 8, a flow chart for monitoring network activity and communicating the monitored activity to a CNA is described. At step 225, MNA 100 and CNA 95 engage in the IP discovery exchange described above with reference to FIG. 6 and FIG. 7. MNA 100 monitors the network activity at step 230, that is, MNA 100 runs monitoring engine 105 to read all network packets from/to MNA 100 to/from Internet 45 and determines the network activity represented in the packets. If MNA 100 is determined to have a communicable IP address at step 235 and CNA 95 is determined to have a communicable IP address as well, at step 240, MNA 100 starts a P2P communication session with CNA 95 to transmit the network activity to CNA 95, at step 250. CNA 95 then may passively analyze the network information or send commands from command set 125 to MNA 100 for the MNA to perform an action that controls its network activity, such as blocking MNA 100 from entering a chat room.

If MNA 100 is determined to have a communicable IP address but CNA 95 does not, at step 240, then MNA 100 may not be able to engage in a P2P communication session with CNA 95. Instead, MNA 100 and CNA 95 engage in a H-P2P session where MNA 100 may designate a local information buffer to store the network activity information from which CNA 95 may periodically pull the information, at step 245. MNA 100 also may designate a command buffer to receive commands sent by CNA 95 periodically. If neither MNA 100 nor CNA 95 has a communicable IP address, e.g. when both MNA 100 and CNA 95 sit behind NAT, MNA 100 and CNA 95 may communicate by means of a client-server session, where MNA 100 and CNA 95 relay information by means of a server, e.g., an IM server, at step 260.

An H-P2P session also may be used when MNA 100 has a non-communicable address but CNA 95 has a communicable IP address, at step 255. In this case, CNA 95 may designate a local information buffer for MNA 100 to send the network activity information periodically. CNA 95 also may designate a local command buffer to store control commands for MNA 100 to retrieve periodically, at step 265.

It should be understood by one skilled in the art that MNA 100 records network activity into logs throughout the steps illustrated in FIG. 8. The information is recorded into logs using reporting engine 135. The logs may be transmitted to CNA 95 via an IMC when CNA 95 is online, posted on a secure web site accessed only by CNA 95 with a security key, or transmitted by other means, such as via electronic mail, voice mail, fax, among others.

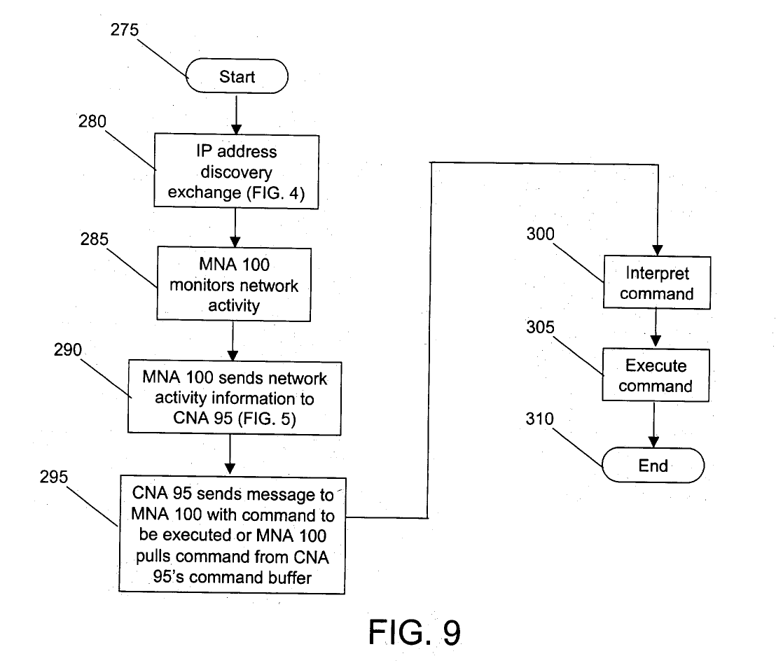

Referring now to FIG. 9, a flow chart for performing an action based on monitored network information is described. At step 280, MNA 100 and CNA 95 engage in the IP discovery exchange described above with reference to FIG. 6 and FIG. 7. MNA 100 monitors the network activity at step 285, that is, MNA 100 runs monitoring engine 105 to read all network packets from/to MNA 100 to/from Internet 45 and determines the network activity represented in the packets.

At step 290, MNA 100 transmits the network activity information to CNA 95 according to the steps described above with reference to FIG. 8. Upon receiving and analyzing the information, CNA 95 sends a message to MNA 100 with a command to be executed (step 295). Lastly, the command is interpreted (step 300) and executed (step 305) by MNA 100 using command set interpreter 130. For example, MNA 100 may block access to a given web site, or may interrupt its Internet connection for a limited period of time.

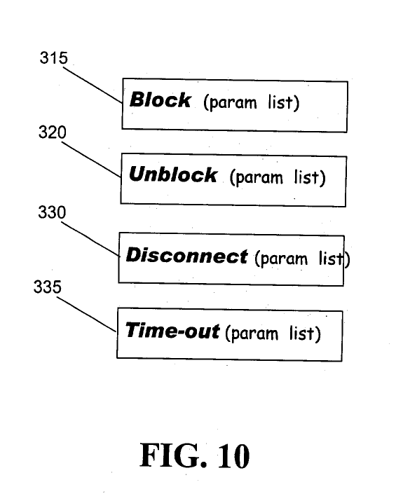

Referring now to FIG. 10, an illustrative diagram of a list of commands in the command set is described. Each command in command set 125 has a command name and a list of parameters corresponding to the command. Block command 315 is a command for blocking MNA 100 from performing a given network activity, such as accessing a web site, chat room, or newsgroup, or from viewing an image or audio file, or from running a given network service, such as IM. Block command 315 has a parameter list to specify the activity or service to be blocked. Unblock command 320 is a command for unblocking an activity or service previously blocked by block command 315.

Disconnect command 330 is a command for disconnecting MNA 100 to Internet 45. Similar to block command 315, disconnect command 330 has a parameter list to specify when MNA 100 is to be disconnected from Internet 45.

Command set 125 may also have command 335 to time-out MNA 100 from using Internet 45 or from using a web browser, IM, or other application. The parameter list associated with time-out command 335 may include the activity or service to be timed-out, among other parameters.

It should be understood by one skilled in the art that IM command set 125 may include additional commands not shown in FIG. 10.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for monitoring and controlling network activity, the method comprising:
analyzing network activity to collect network activity information associated with a monitoring network appliance without user intervention and in real-time;
screening the network activity against a first predefined set of rules;
if required by the first predefined set of rules, modifying the network activity in accordance with the first predefined set of rules; and
selectively transmitting the network activity information to a controlling network appliance in real-time.

2. The method of claim 1, further comprising:
screening the network activity against a second set of the predefined set of rules to determine whether to selectively transmit the network activity information to the controlling network appliance in real-time.

3. The method of claim 1, further comprising sending a command from the controlling network appliance to the monitoring network appliance to control the network activity of the monitoring network appliance.

4. The method of claim 3 wherein sending a command from the controlling network appliance to the monitoring network appliance comprises updating the first predefined set of rules.

5. The method of claim 1 wherein the network activity corresponds to data packets received by the monitoring network appliance, the method further comprising identifying an applicable protocol of the data packets.

6. The method of claim 1, further comprising determining a type of IP address assigned to each of the controlling network appliance and the monitoring network appliance.

7. The method of claim 1, wherein transmitting network activity information to the controlling network appliance comprises selecting a communication routine from a plurality of communication routines for transmitting the network activity information, wherein the communication routine is selected according to the type of IP address assigned to the controlling network appliance and/or the type of IP address assigned to the monitoring network appliance.

8. The method of claim 1 further comprising registering the controlling network appliance as buddy of the monitoring network appliance in an instant messaging system.

9. The method of claim 3, wherein sending a command from the controlling network appliance to the monitoring network appliance to control the network activity of the monitoring network appliance in real-time comprises sending one or more of: a block command; an unblock command; a disconnect command; and a time-out command.

10. The method of claim 3, further comprising interpreting and executing the command in the monitoring network appliance to control the network activity of the monitoring network appliance.

11. The method of claim 1, further comprising:
recording the network activity information into logs; and
transmitting the logs to the controlling network appliance.

12. The method of claim 1, further comprising displaying the network activity information in the controlling network appliance.

13. The method of claim 1, wherein the network activity information is transmitted to two or more controlling network appliances.

14. A method for monitoring and controlling network activity, the method comprising:
analyzing network activity to collect network activity information associated with a monitoring network appliance without user intervention and in real-time;
screening the network activity against a first predefined set of rules to determine whether to selectively transmit the network activity information to the controlling network appliance in real-time; and
if required by the first predefined set of rules, transmitting the network activity information to a controlling network appliance in real-time.

15. The method of claim 14 further comprising sending a command from the controlling network appliance to the monitoring network appliance to control the network activity of the monitoring network appliance in real-time.

16. The method of claim 14, wherein screening network activity comprises screening network activity to determine a content of the network activity.

17. The method of claim 14, wherein screening network activity comprises screening network activity to determine a type of the network activity.

18. The method of claim 14, wherein transmitting the network activity information to the controlling network appliance comprises selecting a communication routine from a plurality of communication routines for transmitting the network activity information, wherein the communication routine is selected according to the type of IP address assigned to the controlling network appliance and/or the type of IP address assigned to the monitoring network appliance.

19. The method of claim 15, wherein sending a command from the controlling network appliance to the monitoring network appliance to control the network activity of the monitoring network appliance in real-time comprises sending one or more of: a block command; an unblock command; a disconnect command; and a time-out command.

20. The method of claim 14 wherein sending a command from the controlling network appliance to the monitoring network appliance updates the first predefined set of rules in the monitoring network appliance.

21. The method of claim 14 wherein the network activity corresponds to data packets received from Internet and/or transmitted to the Internet by the monitoring network appliance, the method further comprising identifying an applicable protocol of the data packets.

22. The method of claim 15, further comprising interpreting and executing the command in the monitoring network appliance to control the network activity of the monitoring network appliance.

23. The method of claim 14, further comprising:
recording the network activity information into logs; and
transmitting the logs to the controlling network appliance.

24. The method of claim 14, further comprising displaying the network activity information in the controlling network appliance.

25. The method of claim 14, wherein the network activity comprises data packets, the method further comprising:
screening the data packets against a second predefined set of rules; and
if required by the second predefined set of rules, modifying the data packets in accordance with the second predefined set of rules.

26. The method of claim 14, further comprising using an instant messaging client in the monitoring network appliance and an instant messaging client in the controlling network appliance for exchanging an IP address assigned to the controlling network appliance and an IP address assigned to the monitoring network appliance between the controlling network appliance and the monitoring network appliance.

27. The method of claim 14 further comprising registering the controlling network appliance as a buddy of the monitoring network appliance in an instant messaging system.

28. The method of claim 14, wherein the network activity information is transmitted to two or more controlling network appliances.

29. A monitoring network appliance for monitoring and controlling network activity, the monitoring network appliance comprising:
a programmed routine for analyzing network activity and collecting network activity information without user intervention and in real-time;
a store for storing a predefined set of rules;
a monitoring routine for screening the network activity against the predefined set of rules, and if required by the predefined set of rules, processing the network activity in accordance with the predefined set of rules; and
a programmed routine for selectively transmitting the network activity information to a controlling network appliance in real-time.

30. The monitoring network appliance of claim 29, wherein the monitoring routine processes the network activity by modifying the network activity in accordance with the predefined set of rules.

31. The monitoring network appliance of claim 29, wherein the monitoring routine processes the network activity by determining whether to selectively transmit the network activity information to the controlling network appliance in real-time.

32. The monitoring network appliance of claim 29, further comprising a programmed routine for receiving a command from the controlling network appliance to control the network activity of the monitoring network appliance.

33. The monitoring network appliance of claim 32 further comprising a routine for updating the predefined set of rules based upon a command received from the controlling network appliance.

34. The monitoring network appliance of claim 29 wherein the network activity corresponds to data packets received by the monitoring network appliance, the monitoring network appliance further comprising a routine for identifying an applicable protocol of the data packets.

35. The monitoring network appliance of claim 34, further comprising a communications routine for determining a type of IP address assigned to each of a controlling network appliance and the monitoring network appliance.

36. The monitoring network appliance of claim 32, further comprising a command interpreter routine for interpreting and executing the command to control the network activity.

37. The monitoring network appliance of claim 29, further comprising a programmed routine for recording the network activity information into logs and periodically transmitting the logs to the controlling network appliance.

38. The monitoring network appliance of claim 29, wherein the monitoring routine screens network activity to determine a content of the network activity.

39. The monitoring network appliance of claim 29, wherein the monitoring routine screens network activity to determine a type of the network activity.

40. The monitoring network appliance of claim 29, further comprising an instant messaging routine for exchanging an IP address with the controlling network appliance.

41. The monitoring network appliance of claim 29 wherein a controlling network appliance is registered as a buddy of the monitoring network appliance.

42. The monitoring network appliance of claim 29, wherein the monitoring network appliance is configured to selectively transmit network activity information to two or more controlling network appliances.
